(19) United States
(12) Patent Application Publication
(10) Pub. No.: US 2009/0237422 A1
(43) Pub. Date: Sep. 24, 2009

(54) Method and apparatus for adjusting the scroll rate of textual media dispayed on a screen

(75) Inventors: Khelan Maheshchandra Modi, Fishers, IN (US); Steven Lee Cooper, Whitestown, IN (US); Chad Andrew Lefevre, Indianapolis, IN (US)

Correspondence Address: MORGAN LEWIS & BOCKIUS LLP, 1111 PENNSYLVANIA AVENUE NW, WASHINGTON, DC, 20004, US

(73) Assignee: TTE Indianapolis

(21) Appl. No.: 12/076,409

(22) Filed: Mar. 18, 2008

(51) Int. Cl. G09G 5/00

(52) U.S. Cl. 345/685

(57) ABSTRACT

A method of presenting emergency alert textual media data on a display unit includes receiving emergency alert textual media data, storing the received emergency alert textual media data into a memory, superimposing the stored emergency alert textual media data on the display unit at an initial scroll rate, detecting a user operation, and adjusting the scroll rate of the superimposed emergency alert textual media data according to the user operation.

### BACKGROUND OF THE INVENTION

1. Field of the Invention

The present invention relates to a method, apparatus, and computer software program for the display of textual media data associated with Emergency Alert System (EAS) events, and more particularly, to adjusting a scroll rate of the textual media data.

2. Discussion of the Related Art

The Emergency Alert System (EAS) is a national system that requires broadcast and cable systems to administer national alerts, warnings, and required testing. The SCTE 18 Standard is a standard published by the Society of Cable Telecommunications Engineers defining the EAS in detail and is a standard that cable service providers and broadcasters may follow to comply with EAS requirements. Under certain circumstances, cable service providers and broadcasters are required to display text associated with an EAS event.

During a television program, a scrolling message containing the EAS event information may be superimposed on the bottom or top of the television screen. SCTE 18 requires that any EAS text information to be displayed on the screen be scrolled “slowly” from the right to the left of the screen. The SCTE 18 standard, however, gives no guidelines on what constitutes “slowly.” Instead, the scroll rate of the EAS text is typically set at a fixed rate that is programmed by the manufacturer of the device displaying the EAS text. This fixed rate of scrolling that is programmed by the manufacturer is often set at a rate that is not convenient for the user. Some users viewing the EAS text may prefer that the EAS text scroll at a slower rate in order to read and understand the text. Whereas other users may prefer that the EAS text scroll at a faster rate so that the entire EAS text may be read in its entirety sooner.

### SUMMARY OF THE INVENTION

Accordingly, the present invention is directed to adjusting a scroll rate of textual media data associated with EAS events that substantially obviates one or more problems due to limitations and disadvantages of the related art.

An object of the present invention is to provide a method, apparatus, and computer software program for adjusting a scroll rate of textual media data associated with EAS events.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the method of presenting emergency alert textual media data on a display unit comprises the steps of receiving emergency alert textual media data, storing the received emergency alert textual media data into a memory, superimposing the stored emergency alert textual media data on the display unit at an initial scroll rate, detecting a user operation, and adjusting the scroll rate of the superimposed emergency alert textual media data according to the user operation.

In another aspect, an apparatus for presenting emergency alert textual media on a display unit comprises an input that receives emergency alert textual media data from a headend, a first memory that stores the received emergency alert textual media data, a decoder that decodes the received emergency alert textual media data stored in the first memory, a second memory that stores the decoded emergency alert textual media data, an encoder that formats the decoded emergency alert textual media data stored in the second memory and sets a scroll rate of the emergency alert textual media data to an initial scroll rate, a processor coupled to the input, second memory, and encoder, the processor adjusting the scroll rate of the formatted emergency alert textual media data stored in the second memory based on a user command, and an output port coupled to the processor and second memory, the output port being controlled by the processor and transmitting the formatted emergency alert textual media data stored in the second memory to the display unit according to the adjusted scroll rate.

In yet another aspect, a program storage device readable by a machine, tangibly embodying a program of instructions executable by the machine to perform the method of adjusting a scroll rate of emergency alert textual media data presented on a display unit comprises the steps of receiving emergency alert textual media data, storing the received emergency alert textual media data into a memory, superimposing the stored emergency alert textual media data on the display unit at an initial scroll rate, detecting a user operation, and adjusting the scroll rate of the superimposed emergency alert textual media data according to the user operation.

In yet another aspect, an apparatus for presenting emergency alert textual media data on a display unit comprises an input that receives emergency alert textual media data from a headend, a memory that stores the received emergency alert textual media data, a decoder that decodes the received emergency alert textual media data stored in the memory, an encoder that formats the decoded emergency alert textual media data and sets a scroll rate of the emergency alert textual media data to an initial scroll rate, a processor coupled to the input and encoder, the processor adjusting the scroll rate of the formatted emergency alert textual media data, and

an output port coupled to the processor, the output port being controlled by the processor and transmitting the formatted emergency alert textual media data to the display unit according to the adjusted scroll rate.

In yet another aspect, an apparatus for presenting emergency alert textual media data on a display unit comprises an input that receives emergency alert textual media data from a headend, a decoder that decodes the received emergency alert textual media data, an encoder that formats the decoded emergency alert textual media data and sets a scroll rate of the emergency alert textual media data to an initial scroll rate, a memory that stores the formatted emergency alert textual media data, a processor coupled to the input, memory, and encoder, the processor adjusting the scroll rate of the formatted emergency alert textual media data stored in the memory based on a user command, and an output port coupled to the processor and memory, the output port being controlled by the processor and transmitting the formatted emergency alert textual media data stored in the memory to the display unit according to the adjusted scroll rate.

In yet another aspect, a method of presenting emergency alert textual media data on a display unit comprises the steps of receiving emergency alert textual media data, storing the received emergency alert textual media data into a memory, superimposing the stored emergency alert textual media data on the display unit at an initial scroll rate, detecting users operations including entering a keyword or phrase and selecting a display option that causes the keyword or phrase to be displayed on the display unit according to the selected display option.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1A illustrates how the text of EAS messages can be displayed on a screen in a horizontal direction;

FIGS. 1B to 1E are illustrations of how the scroll rate of the text of an EAS message of FIG. 1A can be adjusted according to the present invention;

FIG. 2 illustrates an exemplary control device for adjusting the scroll rate of textual media data;

FIG. 3 is a schematic of an exemplary device for adjusting the scroll rate of the text of an EAS message;

FIG. 4 is a flow diagram demonstrating the operation of adjusting the scroll rate of the text of an EAS message;

FIG. 5A illustrates how captioned text from a television show can be displayed on a screen from top to bottom;

FIGS. 5B to 5E illustrate how the scroll rate of the captioned text of FIG. 5A can be adjusted according to the present invention;

FIGS. 6A to 6C are illustrations of how the text of an EAS message can be adjusted according to the present invention.

### DETAILED DESCRIPTION OF THE PREFERRED EMBODIMENTS

Reference will now be made in detail to the preferred embodiments of the present invention, examples of which are illustrated in the accompanying drawings.

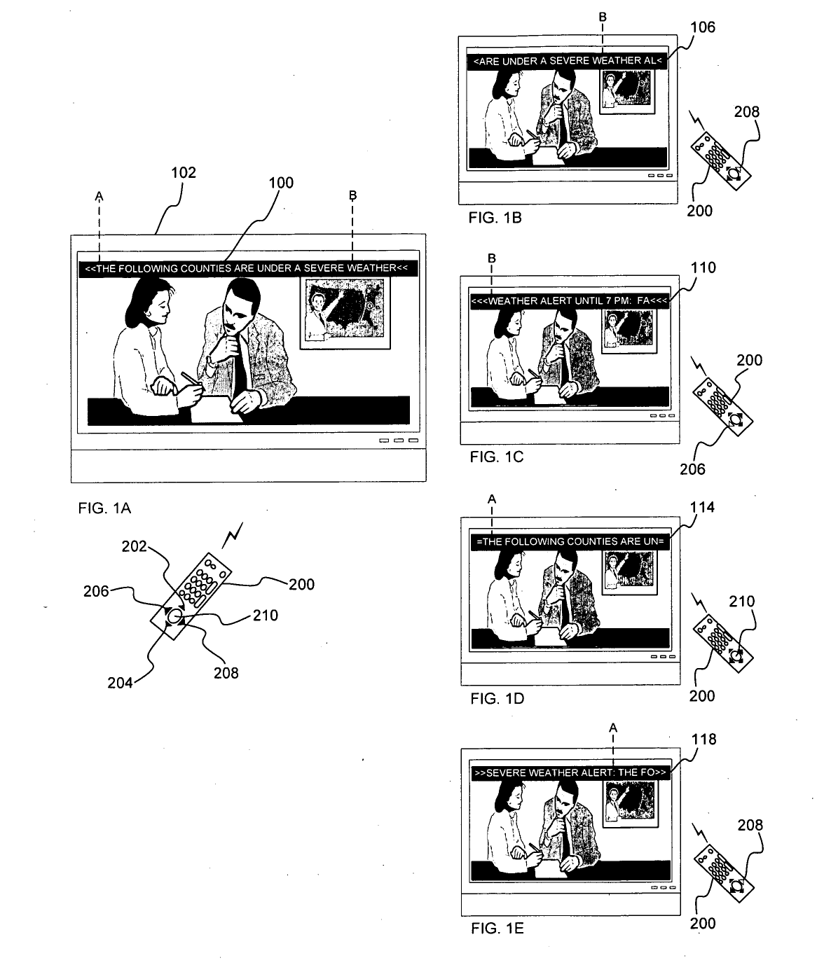

FIG. 1A illustrates how the text of EAS messages can be displayed on a screen in a horizontal direction. As shown in FIG. 1A, a typical EAS message 100 is displayed on a screen of a television unit 102. The television unit 102 can further include a remote control 200 that is operatively linked to the television unit 102. The text of the EAS message 100 is superimposed upon the video output of the television unit 102 and scrolls at a predefined rate from the right of the screen to the left of the screen, as shown by the double left arrows, “<<”, in the EAS message 100. Markers “A” and “B” of the EAS message 100 are position markers that serve as reference points to identify the position of the EAS message 100 during scrolling. Marker A indicates a first position of the EAS message 100 and marker B indicates a second position in the message 100.

FIGS. 1B to 1E are illustrations of how the scroll rate of the text of an EAS message of FIG. 1A can be adjusted according to the present invention. As shown in FIG. 1B, the scroll rate 106 of text of the EAS message may be decreased by pressing the right arrow button 208 of the remote control 200. The decrease in scroll rate 106 is conveyed using the single left arrows, “<”. Additionally, as seen in FIG. 1B using marker B, the scroll rate 106 has decreased. Alternatively, as shown in FIG. 1C, the scroll rate 110 may be increased by pressing the left arrow button 206 of the remote control 200. The increase in scroll rate 110 is conveyed using the triple left arrows, “<<<”, and is shown by the change in the relative position of marker B on the television screen 102. FIG. 1D illustrates how the scroll rate 114 of text of the EAS message may be temporarily paused by pressing the action button 210 of the remote control 200. The temporary pause in scroll rate 114 is conveyed by the equals character, “=”, and is shown by the unchanged relative position of marker A on the television screen 102. Additionally, as shown in FIG. 1E, pressing the right arrow button 208 while the scroll rate 114 has been temporarily paused will cause the scrolling rate 118 to reverse direction until the beginning of the message has been reached. The reverse direction of the scrolling rate 118 is indicated by the double right arrows, “>>”, and is shown by the change in the relative position of marker A. The scroll rate of text displayed on the screen is adjustable by the user so that the message may be read at a rate convenient for the viewer.

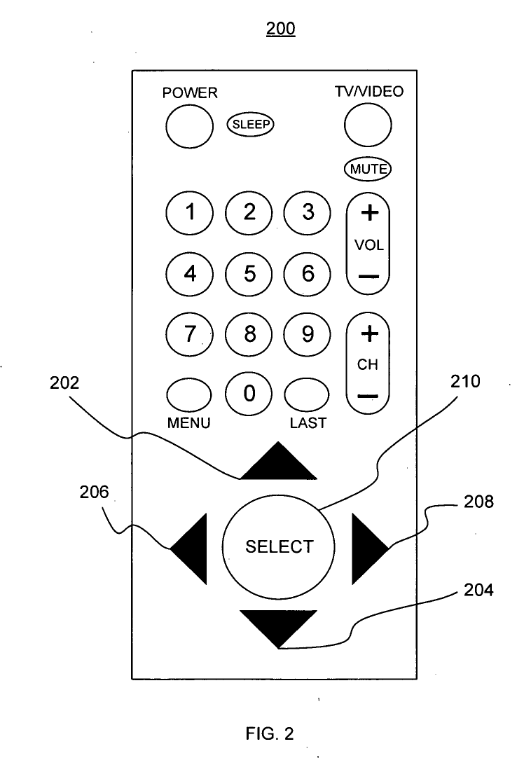

FIG. 2 illustrates an exemplary remote control device for adjusting the scroll rate of textual media. The exemplary control device is a remote control unit 200 operatively linked to a display unit, for example, television unit 102. The navigation keypad of the remote control 200 is comprised of keys 202, 204, 206, 208, and 210 that can adjust the scroll rate of the text displayed on a display unit, such as a television screen. Scrolling text displayed on a screen is often displayed on the screen either from the right to the left of the screen or from the bottom to the top of the screen. Accordingly, the down arrow key 204 and right arrow key 208 operate to decrease the scroll rate of the text because the keys point in the direction opposing the scroll direction. Similarly, the up arrow key 202 and left arrow key 206 act to increase the scroll rate of the text. There are, however, predefined levels at which the scroll rate of the text may not fall below or exceed. In other words, there is a minimum scroll rate that the scroll rate may not fall below and there is a maximum scroll rate that the scroll rate may not exceed. Additionally, the select key 210 can act to temporarily pause the scroll rate of the text. The control device for adjusting the scroll rate of textual media is not limited to remote control units. Other control devices are also envisioned. For example, directional keys on the keypad of the television unit or computer keyboard may be used to adjust the scroll rate. Similarly, a graphical user interface containing navigational buttons or soft keys can be used to adjust the scroll rate of the text. Devices with navigational or directional thumb wheels or joysticks may also be used to adjust the scroll rate.

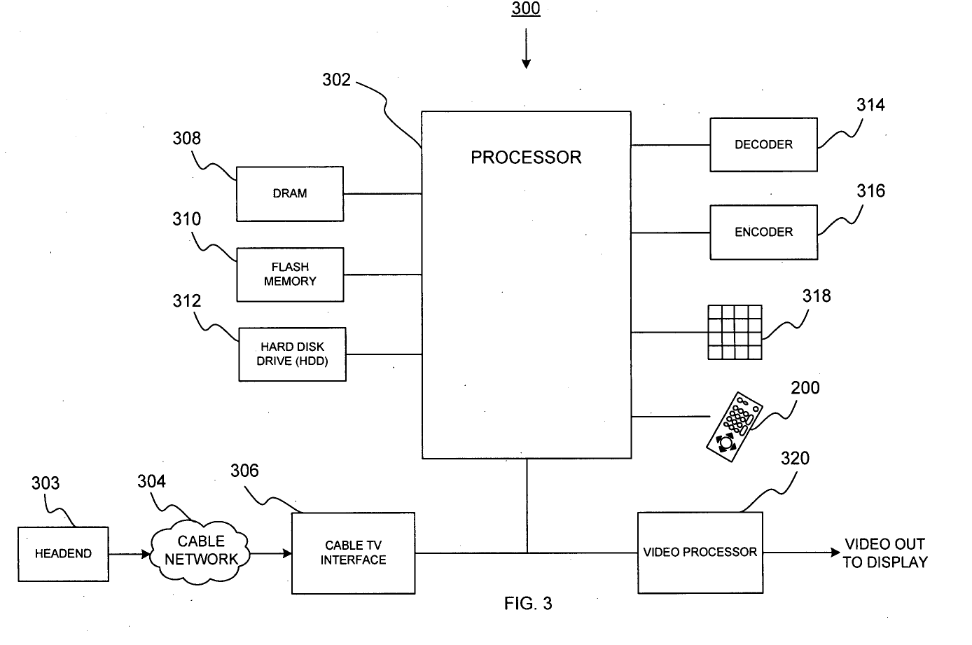

FIG. 3 is a schematic of an exemplary device for adjusting the scroll rate of the text of an EAS message. In this embodiment, the exemplary device 300 is integral with television unit 102. As shown in FIG. 3, the exemplary device includes a processor 302 that is coupled to a cable network 304 via a cable television interface 306. The device 300 also comprises a plurality of memory devices 308, 310, and 312 used for storing the emergency alert message data. The processor 302 is also coupled to a decoder 314 and encoder 316 that decodes and formats the emergency alert message data sent from the headend 303 of a cable network 304. Decoder 314 and encoder 316 can be discrete chips separate from the processor 302 or can be integral with processor 302 and can be implemented as hardware or software, or both. Additionally, processor 302 is coupled to a keypad 318 and a remote control 200, all of which assist in adjusting the scroll rate of the emergency alert message.

The operation of adjusting the scroll rate of EAS messages will now be discussed in greater detail with reference to FIGS. 1A to 3. The EAS event information is sent to the television unit 102 via cable network 304 from the headend 303. After the EAS event information is received, stored, and processed by the apparatus as shown in FIG. 3, it is displayed on the television screen 102, as described in greater detail below.

After the EAS event information is received from the cable network 304 via the cable television interface 306, the data information is stored into one or more of the DRAM 308, flash memory 310, or hard disk drive 312. The EAS data information is subsequently decoded by the decoder 314. The encoder 316 formats the decoded emergency alert message data into a text format to be viewed and superimposed on the screen of the television 102 and whose scroll rate is capable of being adjusted. Additionally, the resulting formatted text information may also be stored into one of the memory devices 308, 310, or 312. The memory devices 308, 310, and 312 may operate to perform similar tasks. As a result, a particular storage task can be executed by any of the memory devices. For example, the decoded or formatted EAS information can be stored in either the DRAM 308, the flash memory 310, or the hard disk drive 312. Additionally, other memory devices such as SDRAM, are contemplated, and are interchangeable with the memory devices listed above to accomplish the same task. Moreover, device 300 need not include all three types of memory 308, 310, and 312, but may rather, include a subset thereof. It is also contemplated that the invention may be implemented without storing of the decoded EAS data information. In this case, the EAS data information is decoded and outputted directly for display. Conversely, it is also contemplated that the invention may be implemented without storage of the received EAS data information. In this case, the EAS data is stored only in RAM after it has been decoded. Thereafter, the stored raw EAS data information is appropriately formatted and output to the device display.

After the EAS information is formatted into a text format whose scroll rate is capable of being adjusted, the formatted information is sent to the video processor 320 to be displayed on the screen of the television 102. The EAS text information is initially displayed and scrolled from the right of the screen to the left at an initial, predetermined rate as shown in FIG. 1A. The viewer can choose to adjust the scroll rate by operating the keypad 318 or remote control unit 200.

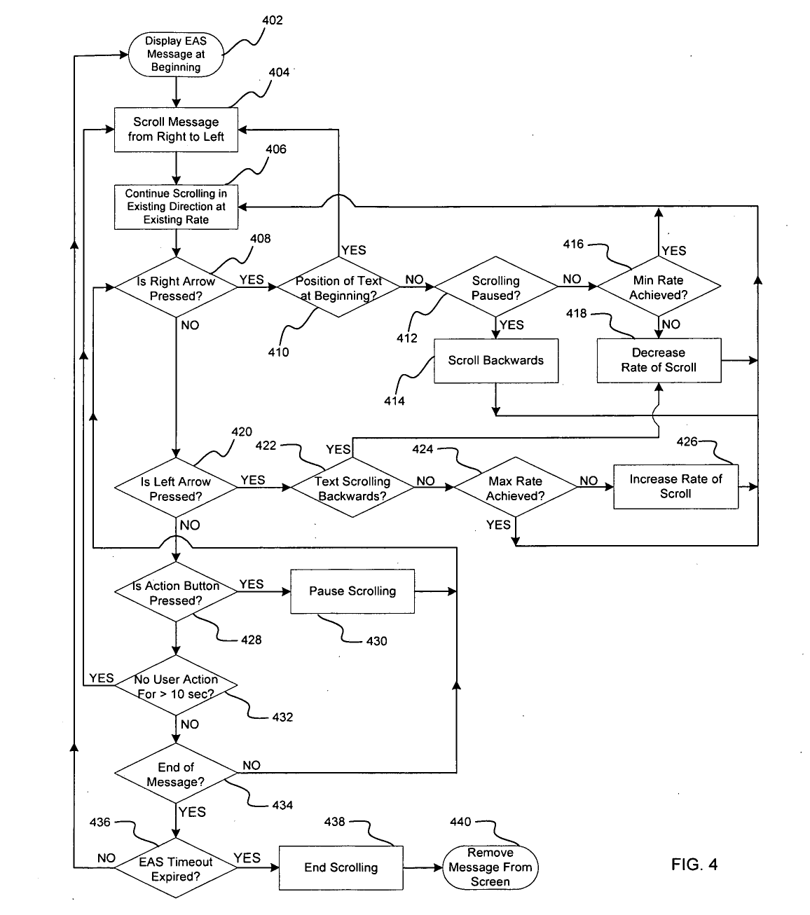

FIG. 4 is a flow diagram demonstrating the operation of adjusting the scroll rate of the text of an EAS message. The EAS text message is displayed on the screen of the television unit (step 402) and the message is scrolled in the direction of right to left at an initial predetermined rate (step 404). The message continues scrolling in this direction (step 406) until a user operation to adjust the scroll rate is detected.

In some instances, the rate at which the text of the EAS message scrolls may be too fast for some viewers to read. It is often difficult to absorb and comprehend messages that are displayed too quickly. If the viewer chooses to view the EAS text message at a slower rate, this can be done by pressing the right arrow button 208 of the remote control 200 (step 408). However, if the position of the text is already located at the beginning of the EAS text message (step 410), in other words, the text is not currently scrolling, the scroll rate of the text is not decreased and the message will begin scrolling from the right of the screen to the left of the screen (step 404). Alternatively, if the position of text is not located at the beginning of the message, it must be determined whether or not the scrolling is currently paused (step 412). If the scrolling is not currently paused and if the scroll rate is not at the minimum scroll rate (step 416), then the rate of scrolling will be decreased (step 418). Once the scroll rate of the text is decreased, the text will continue scrolling at the decreased rate in the existing forward direction (step 406). If the scroll rate of text was determined to be at a pause (step 412), then pressing the right arrow button while the scroll rate is paused causes the text to scroll backwards (step 414). The text will continue to scroll at this rate in the backwards direction (step 406). Thus, a viewer need not waste time and wait for the entire message to loop back to the beginning to read a relevant portion of the message that has just left the screen. Adjusting the scroll rate allows the user to read at a rate that is comfortable and convenient to the viewer.

If the viewer chooses to view the EAS text message at a faster rate and view the message in a shorter amount of time, this can be done by pressing the left arrow button 206 of the remote control 200 (step 420). However, if the text is currently scrolling backwards (step 422), pressing the left arrow button will cause the rate of the backwards scrolling to decrease (step 418). If the text is already scrolling in the forward direction at the maximum pre-determined rate, pressing the left arrow key produces no results and the text will continue to scroll in the forward direction at the maximum rate (step 406). Thus, if the text is not currently scrolling backwards and the text is not scrolling in the forward direction at the maximum rate (step 424), pressing the left arrow button causes the scroll rate to be increased (step 426). Increasing the scroll rate gives viewers who may be under time constraints to read the message in its entirety in less time. The ability to increase the scroll rate also allows viewers to quickly move ahead to the portions of the EAS message that are pertinent to the viewer.

In certain instances, the viewer may wish to pause the scrolling of the EAS text (step 428). This can be accomplished by pressing the action button 210 of the remote control 200 (step 430). The text, however, is only temporarily paused for a predetermined duration that may be set by the manufacturer, or until another user operation is detected. Additionally, should no user interaction be detected after ten seconds, or some other duration set by the manufacturer, the text will resume scrolling in the forward direction (step 404).

The viewer can continue to adjust the scroll rate of the EAS text message for the entire duration that the message is presented on the television screen 102. Once the end of the EAS message is reached (step 434) and the EAS text message timeout has expired (step 436) the scrolling is ceased (step 438) and the EAS message is removed from the screen (step 440). However, if the EAS message timeout has not expired, the EAS message resumes scrolling in the forward direction (step 404). If during the process of presenting the EAS message the EAS message timeout expires, the message will continued to be displayed until the end of the message is displayed to the viewer (step 434).

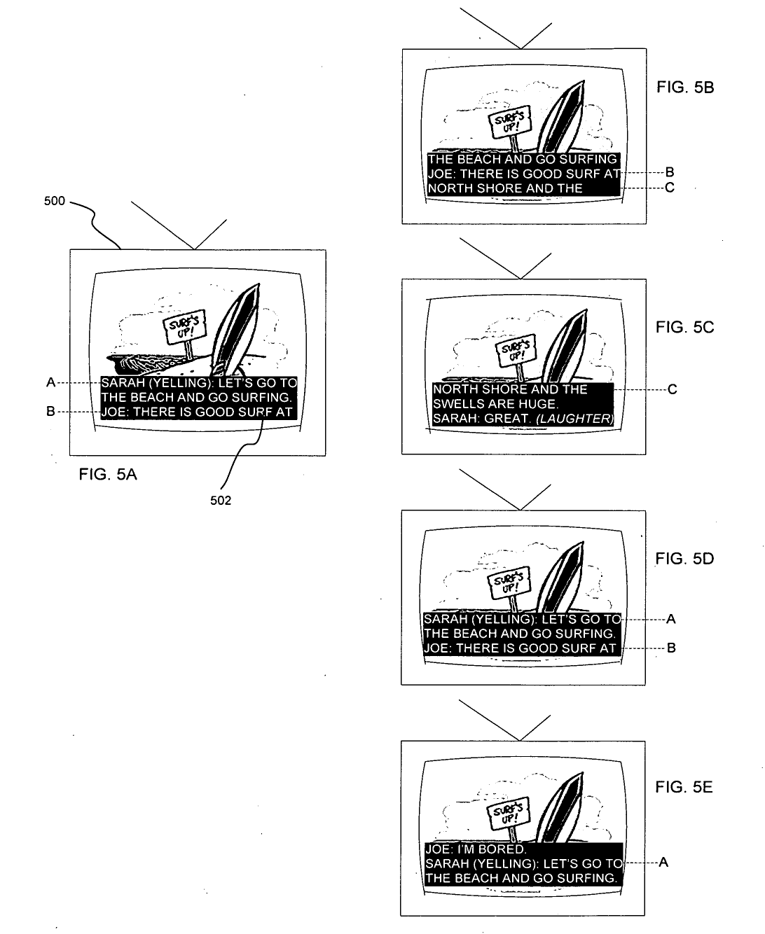

As another example of an embodiment of the invention, FIG. 5A illustrates how captioned text from a television show can be displayed on a screen from top to bottom and FIGS. 5B to 5E illustrate how the scroll rate of the captioned text 502 of FIG. 5A can be adjusted according to the present invention. In this embodiment, the text captioned from a television show is presented as roll-up captions 502 on the television screen 500. The captioned text 502 appears one line at a time from the bottom of the screen to the top of the screen. In FIGS. 5A to 5E, markers “A”, “B”, and “C” of the captioned text 502 are position markers that serve as reference points to identify the position of the captioned text during scrolling. The roll-up captioning of the television set 500 retains many of the features and essential elements of the scrolling EAS message of the television set 102 illustrated in FIGS. 1A to 1E and FIG. 3 and performs in a manner very similar to the television set 102. Thus, for example, in the exemplary embodiment of FIG. 5B, the scroll rate of the captioned text may be decreased by pressing the down arrow key (not shown). This decrease in scroll rate is shown by the relative positions of markers B and C. Similarly, as shown in FIG. 5C by the relative position of marker C, the scroll rate of the text may be increased by pressing the up arrow key of the remote control (not shown). As shown in FIG. 5D by the relative positions of markers A and B, the scroll rate of the text may be paused by pressing the action key of the remote control (not shown). Additionally, as shown in FIG. 5E by the relative position of marker A, the scroll rate of the text may be reversed by selecting the down arrow key while the scroll rate has been temporarily paused. All of the previously described configurations and methods of adjusting the scroll rate of the text to be displayed on the screen are equally applicable to this embodiment.

Additionally, the present device and method for adjusting the scroll rate of textual media need not be limited to cable television systems for the Emergency Alert System, but also has utility in any media environment where textual messages and information are presented in a scrolling manner. For example, as shown in FIG. 5, the scroll rate of the captioned text of a television show may be adjusted by the viewer. The present device may also be embodied on a computer chip to be installed into a variety of devices such as set-top decoders and VCRs, or any device coupled to a display unit capable of formatting or displaying textual media.

Applicability of the present invention to closed captioned text and teletext is also contemplated. The present invention may also be directed to other forms of captioning such as roll-up captioning, where text is displayed from the bottom of the screen one line at a time and pop-on captioning, where all previous captions are erased when a new caption block is displayed. Moreover, “scrolling” text is not limited to text that moves in a continuous manner from the right of the screen to the left or from the bottom of the screen to the top. Instead, scrolling text refers to text whose display is defined by some movement or rate.

Furthermore, it is also contemplated that the present invention enables the viewer to scroll or quickly move ahead to the portions of the EAS message or captioned text by allowing the viewer to search the textual media. The viewer can input search terms using a keypad and quickly move ahead to the relevant portions of the textual message that are of interest to the viewer. For example, the viewer may only be interested in portions of the EAS message applicable to a particular location. Likewise, the viewer may be interested in viewing a specific segment of captioned text from a television show and is able to identify a particular topic of interest or a particular word in that segment. A searchable text feature can allow the viewer to quickly access relevant portions of the textual media.

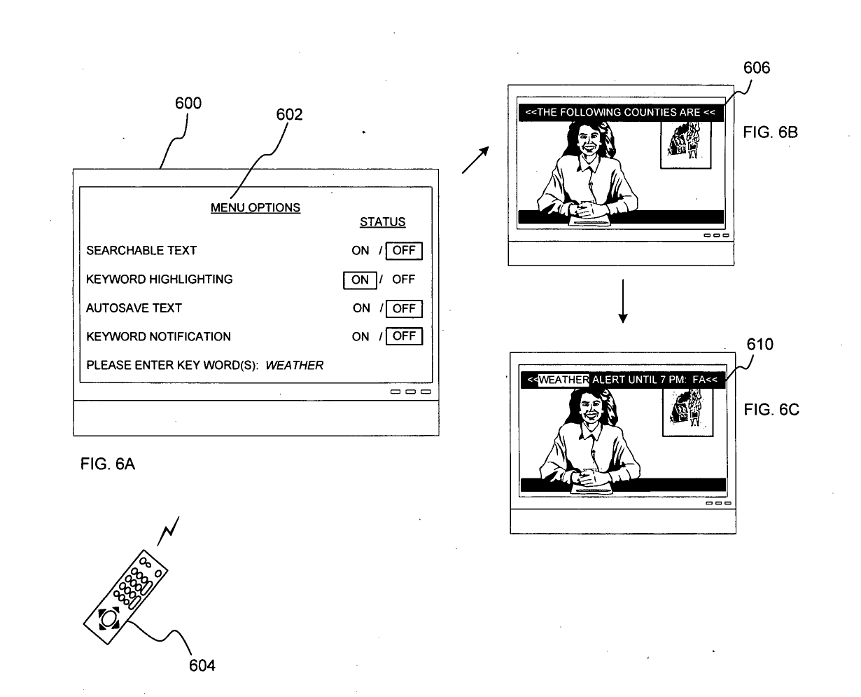

Similarly, as illustrated in FIGS. 6A to 6C, the present invention also contemplates the ability to highlight key words or phrases, providing additional clarity for the user and allowing the user to easily identify relevant text or quickly move ahead to relevant portions of the textual media. For example, in the context of EAS messages and as shown in FIG. 6A, the user can input key words to be highlighted, such as events or locations such as a county, city, or state. This can be accomplished using the keypad on the remote control 604 via a menu screen 602 on the television set 600. FIG. 6B is an illustration of an EAS message 606 displayed on the television screen. As shown in FIG. 6C, the key words entered by the user would appear highlighted in the text of the EAS message 610 and would allow the user to easily scroll forward or backwards to the relevant portions of the message, or to more clearly view the textual media. In the context of other captioned text, the user may wish to highlight show titles, character names, or other words or phrases. The user may also choose to auto-save text surrounding the key words or phrases. For example, selecting key words such as “weather” or “sunny,” could allow the user to auto-save the captioned text relating to weather forecast for viewing at a later time.

It will be apparent to those skilled in the art that various modifications and variations can be made in the method of adjusting the scroll rate of textual media of the present invention without departing from the spirit or scope of the invention. Thus, it is intended that the present invention cover the modifications and variations of this invention provided they come within the scope of the appended claims and their equivalents.

What is claimed is:

1. A method of presenting emergency alert textual media data on a display unit, the method comprising:
receiving emergency alert textual media data;
storing the received emergency alert textual media data into a memory;
superimposing the stored emergency alert textual media data on the display unit at an initial scroll rate;
detecting a user operation; and
adjusting the scroll rate of the superimposed emergency alert textual media data according to the user operation.

2. The method of claim 1, wherein the user operation comprises at least one of:
operating a keypad operatively linked to the display unit;
operating a remote control unit operatively linked to the display unit; or
operating a graphical user interface operatively linked to the display unit.

3. The method of claim 2, wherein the user operation further comprises at least one of:
operating a first button that results in increasing the scroll rate;
operating a second button that results in decreasing the scroll rate;
operating a third button that results in pausing the scroll rate; or
operating one of the first, second, or third buttons that results in reversing a direction of scrolling.

4. The method of claim 1, wherein the superimposed emergency alert textual media data scrolls from the bottom of the display unit to the top of the display unit.

5. The method of claim 1, wherein the superimposed emergency alert textual media data scrolls from the right of the display unit to the left of the display unit.

6. An apparatus for presenting emergency alert textual media data on a display unit, comprising:
an input that receives emergency alert textual media data from a headend;
a first memory that stores the received emergency alert textual media data;
a decoder that decodes the received emergency alert textual media data stored in the first memory;
a second memory that stores the decoded emergency alert textual media data;
an encoder that formats the decoded emergency alert textual media data stored in the second memory and sets a scroll rate of the emergency alert textual media data to an initial scroll rate;
a processor coupled to the input, second memory, and encoder, the processor adjusting the scroll rate of the formatted emergency alert textual media data stored in the second memory based on a user command; and
an output port coupled to the processor and second memory, the output port being controlled by the processor and transmitting the formatted emergency alert textual media data stored in the second memory to the display unit according to the adjusted scroll rate.

7. The apparatus of claim 6, wherein the user command is entered using at least one of the following:
a keypad operatively linked to the display unit;
a remote control unit operatively linked to the display unit; or
a graphical user interface operatively linked to the display unit.

8. The apparatus of claim 7, wherein the user command is entered using at least one of the following:
a first button that when operated results in increasing the scroll rate;
a second button that when operated results in decreasing the scroll rate;
a third button that when operated results in pausing the scroll rate; or
one of the first, second, or third buttons that when operated results in reversing a direction of scrolling.

9. The apparatus of claim 6, wherein the superimposed emergency alert textual media data scrolls from the bottom of the display unit to the top of the display unit.

10. The apparatus of claim 6, wherein the superimposed textual media scrolls from the right of the display unit to the left of the display unit.

11. A program storage device readable by a machine, tangibly embodying a program of instructions executable by the machine to perform the method of adjusting a scroll rate of emergency alert textual media data presented on a display unit, comprising the steps of:
receiving emergency alert textual media data;
storing the received emergency alert textual media data into a memory;
superimposing the stored emergency alert textual media data on the display unit at an initial scroll rate;
detecting a user operation; and
adjusting the scroll rate of the superimposed emergency alert textual media data according to the user operation.

12. The program storage device of claim 11, wherein the user operation comprises at least one of:
operating a keypad operatively linked to the display unit;
operating a remote control unit operatively linked to the display unit; or
operating a graphical user interface operatively linked to the display unit.

13. The program storage device of claim 12, wherein the user operation further comprises at least one of:
operating a first button that results in increasing the scroll rate;
operating a second button that results in decreasing the scroll rate;
operating a third button that results in pausing the scroll rate; or
operating one of the first, second, or third buttons that results in reversing the direction of scrolling.

14. The program storage device of claim 11, wherein the superimposed emergency alert textual media data scrolls from the bottom of the display unit to the top of the display unit.

15. The program storage device of claim 11, wherein the superimposed emergency alert textual media data scrolls from the right of the display unit to the left of the display unit.

16. An apparatus for presenting emergency alert textual media data on a display unit, comprising:
an input that receives emergency alert textual media data from a headend;
a memory that stores the received emergency alert textual media data;
a decoder that decodes the received emergency alert textual media data stored in the memory;
an encoder that formats the decoded emergency alert textual media data and sets a scroll rate of the emergency alert textual media data to an initial scroll rate;
a processor coupled to the input and encoder, the processor adjusting the scroll rate of the formatted emergency alert textual media data; and
an output port coupled to the processor, the output port being controlled by the processor and transmitting the formatted emergency alert textual media data to the display unit according to the adjusted scroll rate.

17. An apparatus for presenting emergency alert textual media data on a display unit, comprising:
an input that receives emergency alert textual media data from a headend;
a decoder that decodes the received emergency alert textual media data;
an encoder that formats the decoded emergency alert textual media data and sets a scroll rate of the emergency alert textual media data to an initial scroll rate;
a memory that stores the formatted emergency alert textual media data;
a processor coupled to the input, memory, and encoder, the processor adjusting the scroll rate of the formatted emergency alert textual media data stored in the memory based on a user command; and
an output port coupled to the processor and memory, the output port being controlled by the processor and transmitting the formatted emergency alert textual media data stored in the memory to the display unit according to the adjusted scroll rate.

18. A method of presenting emergency alert textual media data on a display unit, the method comprising:
receiving emergency alert textual media data;
storing the received emergency alert textual media data into a memory;
superimposing the stored emergency alert textual media data on the display unit at an initial scroll rate;
detecting users operations including:
entering a keyword or phrase; and
selecting a display option that causes the keyword or phrase to be displayed on the display unit according to the selected display option.

19. The method of claim 18, wherein the keyword or phrase is entered by one or more of:
operating a keypad operatively linked to the display unit;
operating a remote control unit operatively linked to the display unit; or
operating a graphical user interface operatively linked to the display unit.

20. The method of claim 18, wherein the display option includes:
searchable textual media data;
keyword or phrase highlighting; or
autosaveable textual media data.
